(19) United States
(12) Patent Application Publication
(10) Pub. No.: US 2026/0180114 A1
(43) Pub. Date: Jun. 25, 2026

(54) Cell Array Structure, and Battery Pack and Vehicle Including the Same

(71) Applicant: LG Energy Solution, Ltd., Seoul (KR)

(72) Inventors: Eui-Cheol Jeong, Daejeon (KR); Jae-Hun Chung, Daejeon (KR); Jin-Oh Yang, Daejeon (KR); In-Se Yoon, Daejeon (KR); Jae-Young Jang, Daejeon (KR); Tae-Woong Choi, Daejeon (KR)

(73) Assignee: LG Energy Solution, Ltd., Seoul (KR)

(21) Appl. No.: 19/428,735

(22) Filed: Dec. 22, 2025

(30) Foreign Application Priority Data
Dec. 23, 2024 (KR) 10-2024-0193898
Mar. 25, 2025 (KR) 10-2025-0038231

(51) Int. Cl. H01M 50/293; B60L 50/64; H01M 10/613; H01M 10/625; H01M 10/643; H01M 10/6556; H01M 50/213; H01M 50/249; H01M 50/291; H01M 50/55

(52) U.S. Cl. CPC H01M 50/293; H01M 10/613; H01M 10/625; H01M 10/643; H01M 10/6556; H01M 50/213; H01M 50/249; H01M 50/291; H01M 50/55; B60L 50/64; H01M 2220/20

(57) ABSTRACT

A cell array structure including a plurality of battery cells; and at least one side structure configured to accommodate and support the plurality of battery cells is provided. The side structure includes a cell contact portion configured such that at least a portion thereof is in contact with the battery cells and a cooling member contact portion having a bottom surface formed to be in contact with a predetermined area of a cooling member and is configured to cool the battery cells.

### CROSS-REFERENCE TO RELATED APPLICATIONS

This application claims the benefit of foreign priority to Korean Applications KR 10-2025-0038231, filed Mar. 25, 2025, and KR 10-2024-0193898, filed Dec. 23, 2024, the entire contents of which are incorporated by reference herein.

### TECHNICAL FIELD

The present disclosure relates to a cell array structure, and a battery pack and a vehicle including the same, and more specifically, to a cell array structure optimized for bottom cooling, and a battery pack and a vehicle including the same.

### BACKGROUND

Recently, as the demand for portable electronic products such as laptops, video cameras, and mobile phones has increased rapidly and the development of electric vehicles, energy storage batteries, robots, and satellites has begun in earnest, research on high-performance secondary batteries capable of repeated charging and discharging is actively being conducted.

Currently commercialized secondary batteries include nickel-cadmium batteries, nickel-metal hydride batteries, nickel-zinc batteries, and lithium-ion secondary batteries. Among them, lithium-ion secondary batteries are attracting attention due to their advantages of being able to charge and discharge freely, having a very low self-discharge rate, and having a high energy density, as they have almost no memory effect compared to nickel-based secondary batteries.

The lithium ion secondary batteries mainly use lithium oxide and carbon material as the positive electrode active material and the negative electrode active material, respectively. In addition, the lithium ion secondary battery includes an electrode assembly in which a positive electrode plate and a negative electrode plate respectively coated with the positive electrode active material and the negative electrode active material are arranged with a separator therebetween, and an exterior that hermetically accommodate the electrode assembly together with an electrolyte.

Meanwhile, lithium-ion secondary batteries may be classified into pouch-type secondary batteries in which the electrode assembly is built in a pouch of an aluminum laminate sheet, and can-type secondary batteries in which the electrode assembly is built in a metal can, depending on the shape of the battery case. In addition, can-type secondary batteries may be further classified into cylindrical batteries and square batteries, depending on the shape of the metal can. The lithium-ion secondary batteries are assembled into a dense structure by overlapping or stacking multiple battery cells mounted on one another or in cartridges, etc., and then electrically connecting them, and then are used as a battery module or battery pack in order to provide high voltage and high current.

Recently, research and development has been actively conducted on battery packs, which are composed of a single module or cell group (hereinafter, referred to as a cell array structure) in which a plurality of cylindrical battery cells are erected and densely packed to provide improved structural rigidity, and a pack frame surrounding the same. In particular, the size of the cell array structure is tending to become larger in order to increase energy capacity.

Conventional cell array structures may include a side structure for accommodating and supporting battery cells. Conventional side structures may be manufactured from plastic injection molding, which results in low thermal conductivity and makes it difficult to perform a cooling function. Conventional cell array structures may additionally include cooling means disposed between battery cells, and cooling is mainly achieved through the so-called side cooling method, in which cooling is performed at the side portion of the battery cells. The cooling means may provide cooling channels or tubes extending through a plate having cooling fluid conducted through. In a conventional cell array structure, for example, battery cells may be arranged in rows with conventional plastic side structures between first and second rows, third and fourth rows, fifth and sixth rows, and etc., while side cooling means may be provided between second and third rows, fourth and fifth rows, and etc. The plastic side structures with low thermal conductivity do not effectively dissipate heat from sides of cells on which they are arranged, while the cooling means employ multiple fluid connections at the end of each cooling means as well as require sufficient space between rows of cells to transmit sufficient cooling fluid to effectively cool the battery cells.

However, recently, there is an increasing demand for so-called bottom cooling, which allows cooling at the bottom of the battery cells, and therefore, there is a need to develop a cell array structure optimized for bottom cooling.

### SUMMARY

### Technical Problem

The present disclosure is designed in consideration of the above technical background, and therefore the present disclosure is directed to providing a cell array structure optimized for bottom cooling, and a battery pack and a vehicle including the same.

The technical problems that the present disclosure seeks to solve are not limited to the above-mentioned problems, and other problems not mentioned above will be clearly understood by those skilled in the art from the detailed description below.

### Technical Solution

In one aspect of the present disclosure, there is provided a cell array structure comprising: a plurality of battery cells; and a side structure configured to accommodate and support battery cells of the plurality of battery cells, wherein the side structure includes: a cell contact portion configured such that at least a portion thereof is in contact with battery cells of the plurality of battery cells; and a cooling member contact portion having a bottom surface formed to be in contact with a predetermined area of a cooling member, where the side structure is configured to transfer heat between battery cells of the plurality of battery cells and the cooling member via the cell contact portion and the cooling member contact portion.

Battery cells of the plurality of battery cells may have a first electrode terminal and a second electrode terminal at a top portion.

The cooling member contact portion includes a portion extending from a bottom portion of the cell contact portion toward a space between adjacent battery cells of the plurality of battery cells.

The bottom surface of the cooling member contact portion may be flat.

The bottom surface of the cooling member contact portion may have the same vertical position relative to the cooling member as a bottom surface of battery cells of the plurality of battery cells.

Battery cells of the plurality of battery cells may be arranged in rows, and at least one side structure may be arranged along each row of battery cells.

The cell contact portion may be in surface contact with side portions of battery cells of the plurality of battery cells.

A contact angle between the cell contact portion and the battery cells may be from 50 to 70 degrees.

The side structure may include metal

The metal may include aluminum.

The side structure may have an electrically insulating coating layer formed on at least a partial surface thereof, and the electrically insulating coating layer may contain an electrically insulating material.

The electrically insulating material may include an epoxy material.

In another aspect of the present disclosure, there is provided a battery pack including the cell array structure according to the present disclosure.

The battery pack according to the present disclosure may further comprise a cooling member arranged at a bottom portion of the cell array structure.

In another aspect of the present disclosure, there is provided a vehicle including at least one battery pack according to the present disclosure.

In another aspect of the present disclosure, there is provided a side structure for accommodating and supporting battery cells in a battery cell array structure, the side structure comprising: a cell contact portion configured such that at least a portion thereof is configured to be in contact with the battery cells; and a cooling member contact portion having a bottom surface configured to be in contact with a predetermined area of a cooling member, where the side structure includes metal and is configured to transfer heat between a plurality of battery cells and the cooling member.

The side structure may have an electrically insulating coating layer formed on at least a partial surface thereof, where the electrically insulating coating layer contains an electrically insulating material.

The electrically insulating material may include an epoxy material.

The cell contact portion may have a corrugated shape.

The cooling member contact portion may be one among a plurality of cooling member contact portions extending alternately on opposing sides of the side structure.

The cooling member contact portion may be one among a plurality of cooling member contact portions extending on only one side of the side structure.

### Advantageous Effects

According to the present disclosure, a cell array structure optimized for bottom cooling, and a battery pack and a vehicle including the same may be provided.

In addition, according to one aspect of the present disclosure, a cell array structure with improved cooling efficiency of battery cells, a battery pack and a vehicle including the same may be provided.

In addition, according to one aspect of the present disclosure, a cell array structure with improved energy density, a battery pack and a vehicle including the same may be provided.

In addition, according to one aspect of the present disclosure, a cell array structure with improved structural rigidity, a battery pack and a vehicle including the same may be provided.

In addition, according to one aspect of the present disclosure, a cell array structure with secured insulation, a battery pack and a vehicle including the same may be provided.

The effects obtainable from the present disclosure are not limited to the above-mentioned effects, and other effects not mentioned above will be clearly understood by those skilled in the art from the detailed description below.

### BRIEF DESCRIPTION OF DRAWINGS

The accompanying drawings illustrate a preferred aspect of the present disclosure and together with the foregoing disclosure, serve to provide further understanding of the technical features of the present disclosure, and thus, the present disclosure is not construed as being limited to the drawing.

FIG. 1 is a perspective view showing the overall appearance of a battery pack according to an aspect of the present disclosure.

FIG. 2 is an exploded perspective view showing the battery pack according to an aspect of the present disclosure.

FIG. 3 a perspective view showing the overall appearance of a cell array structure according to an aspect of the present disclosure.

FIG. 4 is an exploded perspective view showing the cell array structure according to an aspect of the present disclosure.

FIG. 5 is a perspective view showing a side structure according to an aspect of the present disclosure.

FIG. 6 is a front view showing the side structure according to an aspect of the present disclosure.

FIG. 7 is an enlarged front view showing a portion of the cell array structure according to an aspect of the present disclosure.

FIG. 8 is an enlarged plan view showing a portion of the cell array structure according to an aspect of the present disclosure.

FIG. 9A and FIG. 9B are perspective views showing a side structure according to another aspect of the present disclosure.

FIG. 10 is an enlarged front view showing a portion of a battery pack according to an aspect of the present disclosure.

FIG. 11 is a drawing showing a vehicle according to an aspect of the present disclosure.

### DETAILED DESCRIPTION

Hereinafter, preferred aspects of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

In this specification, unless otherwise specified, the X-axis and Y-axis directions may be a horizontal direction, respectively, and the Z-axis direction orthogonal to the X-Y plane may be a vertical direction.

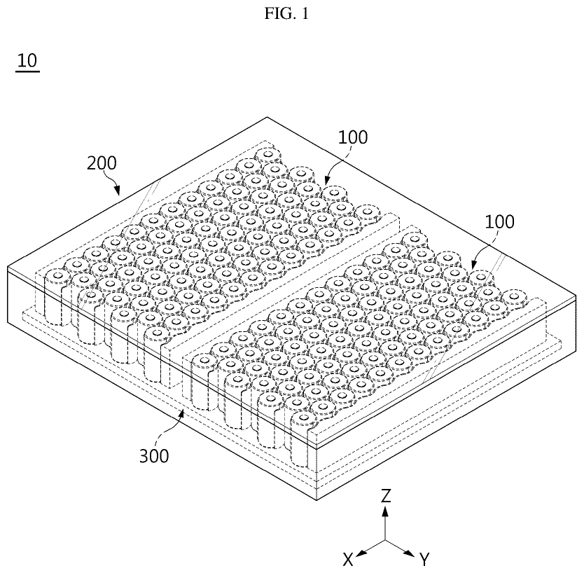

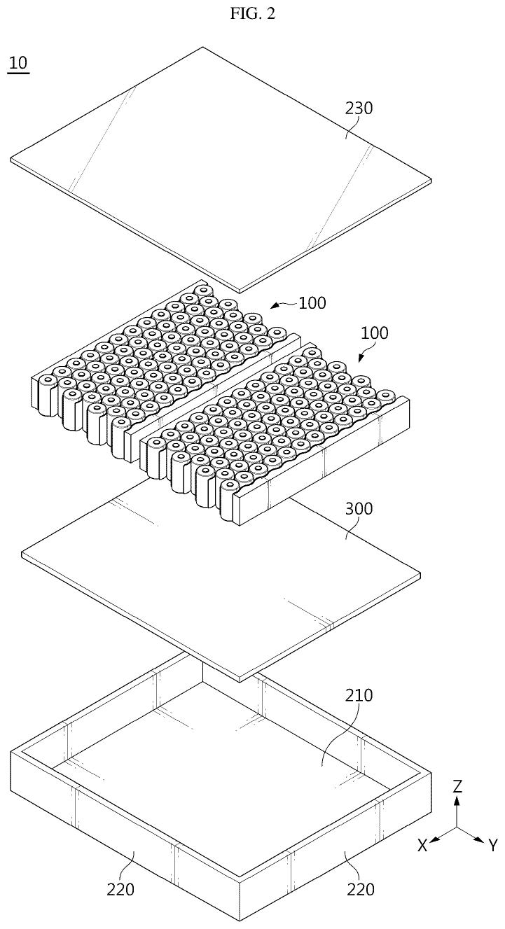

FIG. 1 is a perspective view showing the overall appearance of a battery pack according to an aspect of the present disclosure, and FIG. 2 is an exploded perspective view showing the battery pack according to an aspect of the present disclosure.

Referring to FIGS. 1 and 2, the battery pack 10 according to an aspect of the present disclosure may include at least one cell array structure 100. The battery pack 10 may include a plurality of cell array structures 100.

The battery pack 10 according to an aspect of the present disclosure may further include a cooling member 300. The cooling member 300 may be configured to cool battery cells 110, explained later. A flow path, through which a cooling medium may flow, may be formed inside the cooling member 300.

The cooling member 300 may be provided such that at least a portion thereof is in contact with the cell array structure 100. The cooling member 300 may be disposed at the lower side of the cell array structure 100 so as to be in contact with the bottom portion of the cell array structure 100. For example, the cooling member 300 may be disposed at the −Z direction side of the cell array structure 100. In this case, the battery pack 10 may be provided with a bottom cooling structure. The cooling member 300 may be disposed at the battery pack 10, for example, inside the battery pack 10. In addition, the cooling member 300 may be provided in various shapes and structures, such as being provided as a part of the cell array structure 100, unlike what is illustrated in the drawings.

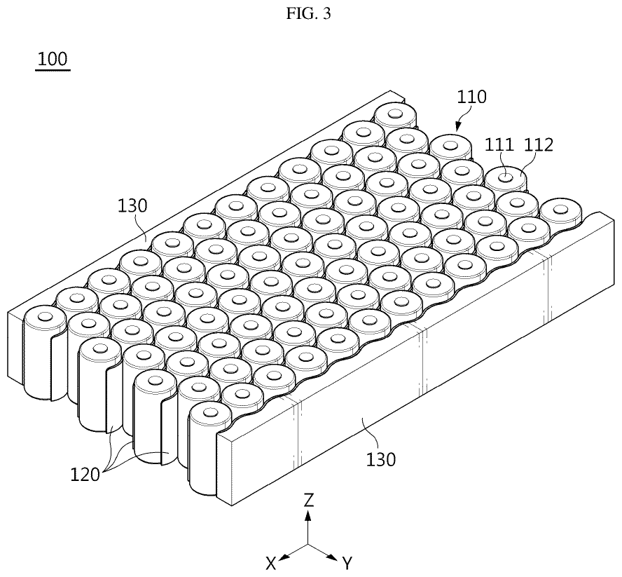

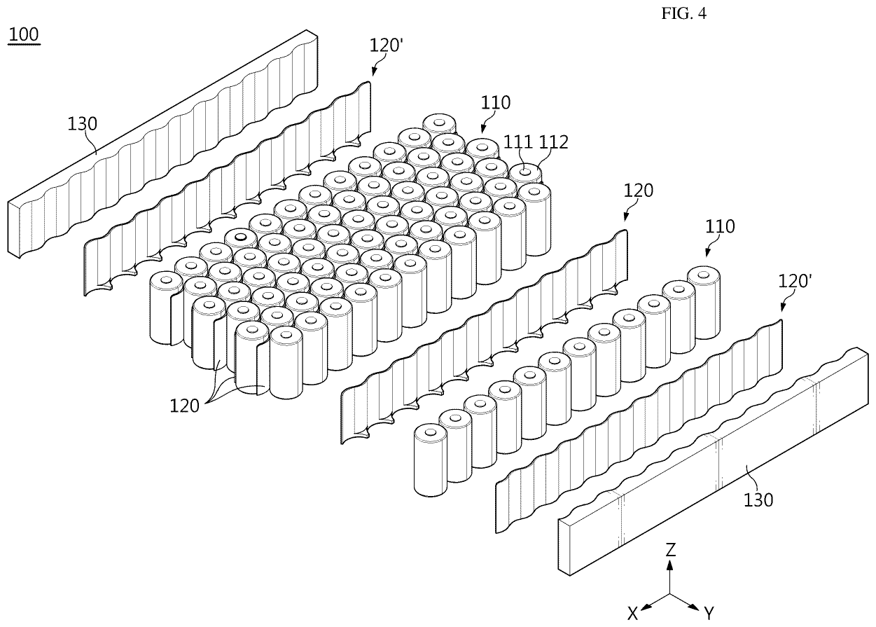

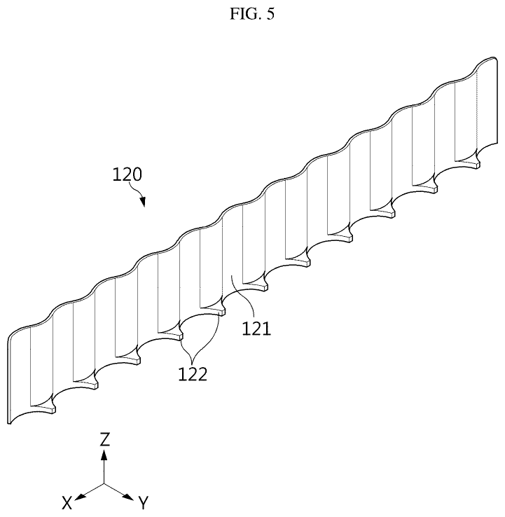

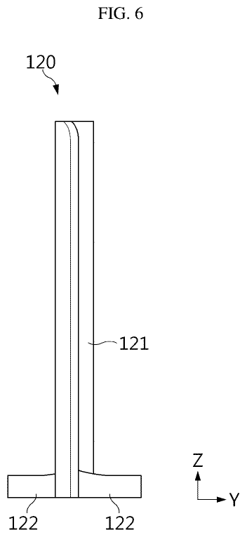

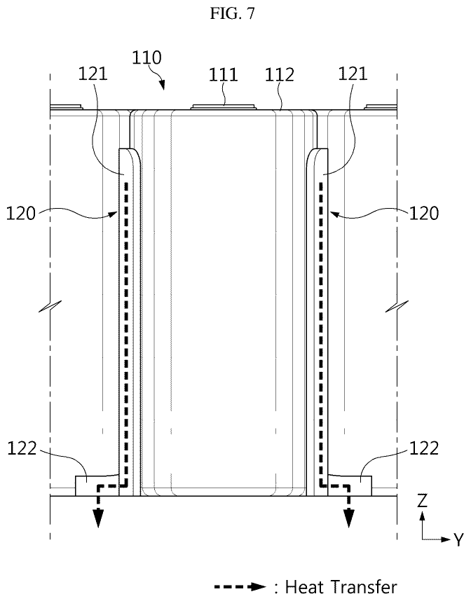

FIG. 3 a perspective view showing the overall appearance of a cell array structure according to an aspect of the present disclosure, FIG. 4 is an exploded perspective view showing the cell array structure according to an aspect of the present disclosure, FIG. 5 is a perspective view showing a side structure according to an aspect of the present disclosure, FIG. 6 is a front view showing the side structure according to an aspect of the present disclosure, and FIG. 7 is an enlarged front view showing a portion of the cell array structure according to an aspect of the present disclosure.

Hereinafter, a cell array structure 100 according to an aspect of the present disclosure will be described in detail with reference to FIGS. 3 to 7.

The cell array structure 100 according to an aspect of the present disclosure may include a plurality of battery cells 110 and at least one side structure 120.

A plurality of battery cells 110 may form the cell array structure 100. The cell array structure 100 may be understood as a single assembly or structure in which a plurality of battery cells 110 are arranged. A battery pack 10 including the cell array structure 100 may be provided in a so-called cell-to-pack structure without including a separate module case, thereby increasing space efficiency and improving energy density. The cell array structure 100 may be configured to have a large area by increasing the number of battery cells 110 arranged.

The cell array structure 100 may have a predetermined length, width, and height. For example, the cell array structure 100 may be a three-dimensional structure having a predetermined length, a predetermined width, and a predetermined height in the X-axis direction, the Y-axis direction, and the Z-axis direction, respectively.

The cell array structure 100 may include at least one side structure 120. The cell array structure 100 may include a plurality of side structures 120, 120′.

The side structure 120, 120′ may accommodate and support a plurality of battery cells 110. The side structure 120, 120′ may be elongated along the longitudinal direction of the cell array structure 100. For example, the side structure 120, 120′ may be elongated along the X-axis direction.

The plurality of battery cells 110 may be arranged to form rows. For example, the plurality of battery cells 110 may be arranged to form rows in a direction parallel to the longitudinal direction or X-axis direction of the cell array structure 100. The battery cells 110 may be cylindrical and the rows of battery cells 110 may be closely packed, such that rows adjacent to one another in the Y-axis direction are offset along the X-axis direction by half of the diameter of a battery cell 110. This can be referred to as hexagonal close packing, as each battery cell 110 other than those around the perimeter will be surrounded by six other battery cells 110 defining a regular hexagon.

The side structure 120, 120′ may be configured to accommodate and support a row of battery cells 110 arranged at one side (in the case of side structure 120′) or to accommodate and support rows of battery cells 110 arranged at both sides (in the case of side structure 120). For example, the side structure 120, 120′ may be configured to accommodate and support a row of battery cells 110 arranged at one side in the Y-axis direction or each of the rows of battery cells 110 arranged at both sides in the Y-axis direction. For example, when the side structure 120′ is arranged at the outermost side of the plurality of battery cells 110, the side structure 120′ may be configured to accommodate and support a row of battery cells 110 arranged at one side. For example, when the side structure 120 is arranged between any two rows of battery cells 110, the side structure 120 may accommodate and support each of the rows of battery cells 110 arranged at both sides.

The side structure 120, 120′ may include a cell contact portion 121 and a cooling member contact portion 122.

At least a part of the cell contact portion 121 may be in contact with adjacent battery cells 110. The cell contact portion 121 may be in contact with a side portion of the adjacent battery cells 110. The cell contact portion 121 may be configured to cool the battery cell 110 via conduction and/or radiation of heat generated in the adjacent battery cells to the cell contact portion. The cell contact portion 121 may be configured to directly cool the battery cell 110. Heat generated in the battery cell 110 may be transferred to the cell contact portion 121 and dissipated to the outside of the battery cell 110.

Contact between the cell contact portion 121 and the and the battery cells 110 may be made by direct physical contact between a surface of the cell contact portion 121 and the battery cells 110. In other examples, any connection between the cell contact portion 121 and the battery cells 110 which permits heat transfer between the cell contact portion 121 and the battery cells 110 may be in contact between the cell contact portion 121 and the battery cells 110. In one example, the cell contact portion 121 and the battery cells 110 may be connected via a thermal transfer resin or adhesive located between the cell contact portion 121 and the battery cells 110. In another example, a thermally conductive layer, film, particle, or plate may be located between the cell contact portion 121 and the battery cells 110. The contact between the cell contact portion 121 and the battery cells 110 may be direct physical contact in one or more regions and may have a thermally conductive material located between the cell contact portion 121 and the battery cells 110 in one or more other regions.

The cooling member contact portion 122 may be a portion of the side structure 120, 120′ that comes into contact with the cooling member 300. Specifically, the cooling member contact portion 122 is a portion that comes into contact with the cooling member 300, and may come into contact with the cooling member 300 when configuring the battery pack 10.

The cooling member contact portion 122 may have a bottom surface formed to be in contact with the cooling member 300. That is, the bottom surface of the cooling member contact portion 122 may be configured to be in contact with the cooling member 300. The bottom surface of the cooling member contact portion 122 may be in contact with the cooling member 300 in a predetermined area. That is, the bottom surface of the cooling member 300 may be in surface contact with the cooling member 300.

Contact between the cooling member contact portion 122 and the cooling member 300 may be made by direct physical contact between a surface of the cooling member contact portion 122 and the cooling member 300. In other examples, any connection between the cooling member contact portion 122 and the cooling member 300 which permits heat transfer between the cooling member contact portion 122 and the cooling member 300 may be in contact between the cooling member contact portion 122 and the cooling portion 300. In one example, the cooling member contact portion 122 and the cooling member 300 may be connected via a thermal transfer resin or adhesive located between the contact portion 122 and the cooling member 300. In another example, a thermally conductive layer, film, particle, or plate may be located between the contact portion 122 and the cooling member 300. The contact between the contact portion 122 and the cooling member 300 may be direct physical contact in one or more regions and may have a thermally conductive material located between the contact portion 122 and the cooling member 300 in one or more other regions.

Heat generated in the battery cells 110 may sequentially pass through the cell contact portion 121 and be conducted to the cooling member contact portion 122, and may ultimately be transferred to the cooling member 300. Specifically, heat generated in the battery cells 110 may be transferred laterally from the battery cells 110 to the cell contact portion 121, the heat transferred to the cell contact portion 121 may be transferred downward again to the cooling member contact portion 122, and the heat transferred to the cooling member contact portion 122 may ultimately be transferred to the cooling member 300.

Additionally, the heat transfer may occur in the reverse direction in order to warm the battery cells 110 if the temperature of the battery cells 110 is below a desired temperature. In this case, the cooling member 300 may be heated, e.g., by being provided with a fluid having a temperature higher than the temperature of the battery cells 110. In which case, the heat from the cooling member 300 may be transferred to the cooling member contact portion 122, and heat transferred to the cooling member contact portion 122 may be transferred to the cell contact portion 121, and the heat transferred to the cell contact portion 121 may be transferred laterally to the battery cells 110.

The cell array structure 100 according to an aspect of the present disclosure has the effect of being optimized for bottom cooling by the above aspect.

Specifically, the cell contact portion 121 of the side structure 120 may stably and firmly accommodate and support the heat of the battery cell 110. In addition, the heat generated in the battery cell 110 may sequentially pass through the cell contact portion 121 and the cooling member contact portion 122 and be transferred to the cooling member 300, and a sufficient contact area between the side structure 120 and the cooling member 300 may be secured by the cooling member contact portion 122, so that the cell array structure 100 according to an aspect of the present disclosure may be optimized for bottom cooling.

In addition, the cell array structure 100 according to the present disclosure may improve the cooling efficiency of the battery cells 110 inside the cell array structure 100 by the side structure 120, 120′.

By using side structures 120, 120′ that facilitate bottom cooling of the battery cells 110 by transferring heat from the sides of the battery cells 110 down to the cooling member 300 along the bottom, the cell array structure 100 according to the present disclosure may have a relatively small volume and weight compared to conventional side structures, which may involve relatively large spaces between the battery cells, for example to accommodate cooling means with fluid channels. That is, due to the relatively thin side structure 120 herein that can be equipped into conventional cell array structures, the space efficiency inside the cell array structure 100 may be increased, also the weight of the cell array structure 100 may be reduced, and also the energy density of the cell array structure 100 may be improved, when compared with conventionally side cooled cell array structures.

In addition, the cell array structure 100 according to the present disclosure may have structural rigidity improved by the side structure 120, 120′.

Each of the plurality of battery cells 110 may include a first electrode terminal 111 and a second electrode terminal 112. The first electrode terminal 111 and the second electrode terminal 112 may be electrode terminals of different polarities. For example, the first electrode terminal 111 may be a positive electrode terminal, and the second electrode terminal 112 may be a negative electrode terminal.

Each of the plurality of battery cells 110 may have a first electrode terminal 111 and a second electrode terminal 112 at the top portion. That is, both the first electrode terminal 111 and the second electrode terminal 112 may be arranged at the top portion of the battery cell 110.

When the cell array structure 100 is configured as above, it is sufficient to provide an electrical connection structure only at the top portion of the plurality of battery cells 110, and thus the cooling member 300 may be disposed at the bottom portion of the cell array structure 100 without interference with the electrical connection structure, etc., so that the cell array structure 100 may be more optimized for bottom cooling.

The cooling member contact portion 122 may be disposed at the bottom portion of the cell contact portion 121. The cooling member contact portion 122 may be formed to extend laterally outwardly from the bottom portion of the cell contact portion 121. The cooling member contact portion 122 may extend toward the space between the plurality of battery cells 110.

The cooling member contact portion 122 may extend laterally outwardly away from the cell contact portion 121 by at least as much as the lateral thickness of the cell contact portion 121, although the cooling member contact portion 122 may extend much farther than that. For example, the shape of the cooling member contact portion 122 may roughly correspond to the shape of the space between the battery cells 110. That is, when viewed in the height direction or Z-axis direction of the cell array structure 100, the shape of the cooling member contact portion 122 may be a sharply protruding shape. In the hexagonally close packed arrangement of battery cells 110, the space between the battery cells 110 may be roughly triangular, in which the sides of the triangle are arcuate and defined by portions of the circular perimeters of two adjacent battery cells 110 and the cell contact portion 121. Thus, the sharply protruding shape of the cooling member contact portion 122 may protrude laterally from the cell contact portion 121 and be defined between two opposing edges that converge towards a point spaced away from the cell contact portion 121, where the converging edges are shaped to define concave arcs. Cooling member contact portions 122 may be absent from end portions of the side structure 120, 120′ on outer sides of the outer battery cells 110. Alternatively, cooling member contact portions 122 may be provided on end portions of the side structure 120, 120′ on outer sides of the outer battery cells 110, in which case the cooling member contact portions 122 may have a smaller size and/or different shape than cooling member contact portions 122 located between adjacent battery cells 100. In one example, cooling member contact portions 122 provided on end portions of the side structure 120, 120′ may have half-triangle shape when compared to cooling member contact portions 122 located between adjacent battery cells 110.

The cooling member contact portion 122 may extend from the cell contact portion 121 toward one or both rows of battery cells 110. For example, the cooling member contact portion 122 may extend from the cell contact portion 121 toward the +Y direction side and/or the −Y direction side. If the side structure 120 is configured to accommodate and support both rows of battery cells 110, the cooling member contact portion 122 may be configured to alternately extend toward the +Y direction side or the −Y direction side along the longitudinal direction or the X-axis direction of the side structure 120. If the side structure 120′ is configured to accommodate and support one row of battery cells 110, the cooling member contact portion 122 may be configured to extend toward either one of the +Y direction side or the −Y direction side along the longitudinal direction or the X-axis direction of the side structure 120′.

If the cooling member contact portion 122 is configured as above, a sufficient contact area SB between the cooling member contact portion 122 and the cooling member 300 may be secured. The contact area SB may be a predetermined area in contact with a predetermined area of the cooling member 300. The contact area SB may be the area of one cooling member contact portion 122 that is in contact with the cooling member 300. In addition, the cooling member contact portion 122 may minimize the gap between the battery cells 110, so that the battery cells 110 may be contacted and supported more firmly. Thus, in some aspects, the contact area SB may occupy at least half of the roughly triangular space between the two adjacent battery cells 110 and the cell contact portion 121. In other aspects, the contact area SB may occupy at least ⅔ of that space. In yet further aspects, the contact area SB may be at least ¾ of that space. In still further aspects, the contact area SB may be 80% or more, 85% or more, 90% or more, or 95% or more of the area of the space between the two adjacent battery cells 110 and the cell contact portion 121.

In particular, referring to FIGS. 6 and 7, the bottom surface of the cooling member contact portion 122 may be formed in a flat shape and may have a flat surface. Although other shapes or surface structures may be used. For example, the bottom surface of the cooling member contact portion 122 may include, for example, grooves, channels, indentations, or protrusions (not shown) to provide additional surface area of the cooling member contact portion 122 when a thermally conductive material is located between the cooling member contact portion 122 and the cooling member 300. The grooves, channels, indentations, or protrusions may alternatively or additionally be provided on the cooling member 300.

The bottom surface of the cooling member contact portion 122 may be formed to be substantially parallel to a plane perpendicular to the height direction or Z-axis direction of the cell array structure 100. For example, the bottom surface of the cooling member contact portion 122 may be formed flat so as to be parallel to the X-Y plane.

If the cooling member contact portion 122 is configured as above, the cooling member contact portion 122 may more effectively come into close contact with the cooling member 300, and thus the cell array structure 100 may be more optimized for bottom cooling.

The bottom surface of the cooling member contact portion 122 may be formed to have the same height (i.e., vertical position relative to the cooling member 300) as the bottom portion of the battery cell 110. That is, the bottom surface of the cooling member contact portion 122 and the bottom portion of the battery cell 110 may be arranged on one plane.

If the cooling member contact portion 122 is configured as above, the space efficiency within the cell array structure 100 may be increased, so that the cell array structure 100 may be made compact and lightweight, and the energy density of the cell array structure 100 may be improved.

In particular, referring to FIGS. 3 and 4, at least one side structure 120 may be arranged in each row of the plurality of battery cells 110.

For example, a plurality of battery cells 110 may be arranged in a plurality of rows, and at least one side structure 120 may be arranged between the rows.

For example, the side structure 120′ may also be arranged at the outermost side of the plurality of battery cells 110, and in this case, at least one side structure 120′ may be arranged at one or both sides of the row of battery cells 110 arranged at the outermost side.

At least one side structure 120, 120′ may be configured to be in contact with each side portion of every battery cell 110 of the cell array structure 100.

If the side structure 120, 120′ is arranged as above, all battery cells 110 of the cell array structure 100 may be accommodated and supported by the side structure 120, 120′, so that the rigidity and structural stability of the cell array structure 100 may be improved. In addition, since each side portion of all battery cells 110 of the cell array structure 100 may be in contact with the side structure 120, 120′, the cooling performance of the cell array structure 100 may be maximized.

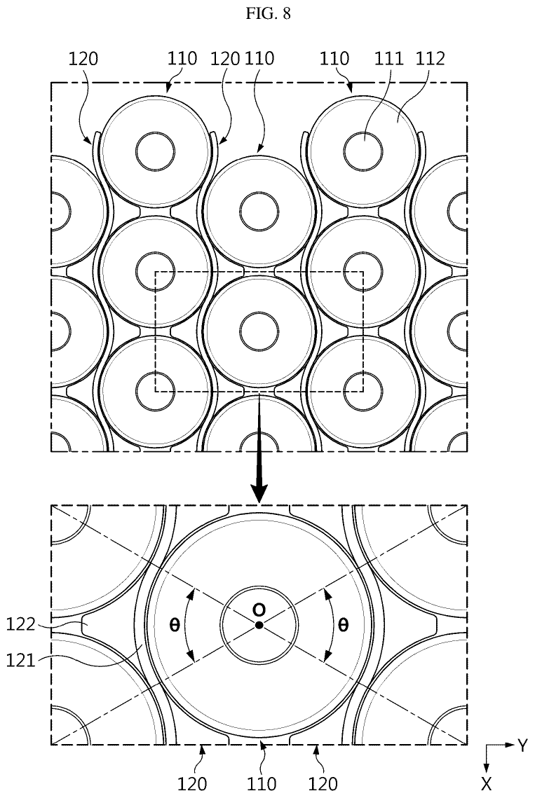

FIG. 8 is an enlarged plan view showing a portion of the cell array structure according to an aspect of the present disclosure.

Referring to FIGS. 3, 4, 7, and 8, the cell contact portion 121 of the side structure 120, 120′ may be in surface contact with the side portion of the battery cell 110.

The cell contact portion 121 may be configured in a repeatedly folded shape, e.g. corrugated or fluted, so as to be in surface contact with at least a portion of the side portions of the adjacent battery cells 110. For example, when the battery cells 110 are provided in a cylindrical shape and are closely packed, the cell contact portion 121 may be configured in a shape with repeated arcs corresponding to the outer circumference of the battery cell 110. The cell contact portion 121 may be configured in a crosswise repeatedly folded shape so as to be in surface contact with each adjacent battery cell 110 between two rows of battery cells 110. The cell contact portion 121 may be configured in an approximately wave shape when viewed in the Z-axis direction.

If the cell contact portion 121 is configured as above, a wide contact area may be secured between the cell contact portion 121 and the side portion of the battery cell 110, so that the heat transfer effect between the battery cell 110 and the cell contact portion 121 may be improved, and thus the cooling performance of the cell array structure 100 may be improved.

In particular, referring to FIG. 8, the contact angle θ of the cell contact portion 121 and the battery cell 110 may be 50 to 70 degrees. For example, the contact angle θ may be approximately 60 degrees. Here, the contact angle θ may be understood as an angle formed between both ends of the arc formed by the contact between one battery cell 110 and the cell contact portion 121 of one side structure 120, 120′, defined about the center O of the battery cell 110, when viewed in the height direction or Z-axis direction of the battery cell 110.

The surface area of a cylindrical battery cell 110 is the height H_{cell} of the battery cells 110 multiplied by the perimeters P of the battery cells 110. The battery cell contact surface area SA is the area of the cell contact portion 121 of one side structure 120, 120′ that is in contact with one battery cell 110. In some examples, the contact angle θ of the cell contact portion 121 (as a fraction of 180°) multiplied by the height of the cell contact portion H_{cp} (as a percentage of H_{cell}) may provide the battery cell contact surface area SA of the battery cell 110 in contact with the cell contact portion 121. In some examples, the contact area between the cell contact portions 121 and the battery cells 110 in a cell array structure 100 may be determined by Equation 1.

$$( \frac{θ}{360 °} ) \times {H}_{cp} \times P {H}_{cell} = S A \qquad ( Equation 1 )$$

In one example, a cell contact portion 121 has a contact angle θ of 50 degrees and a height H_{cp} that is 90% of H_{cell}, so the cell contact portion 121 may provide a battery cell contact surface area SA of

$$( \frac{50 °}{360 °} ) \times 0.9 \times P {H}_{cell} = 12 \text{.5} \% {PH}_{cell} .$$

In another example, the contact angle θ is 70 degrees and the height of the cell contact portion H_{cp} is 80% of H_{cell}, so the cell contact portion 121 may provide a battery cell contact surface area SA of

$$( \frac{70 °}{360 °} ) \times 0.8 \times P {H}_{cell} \approx 15 \text{.6} \% {PH}_{cell} .$$

The person having ordinary skill may choose other contact angles θ and/or heights of the cell contact portion H_{cp} to provide for a desired battery cell contact surface area SA between the cell contact portion 121 and battery cell 110.

In other examples, the battery cell contact surface area SA may vary from Equation 1 when the height of the cell contact portion varies along its length or the contact angle θ is different for some battery cells 110 along the length of the battery cell contact portion 121. In one example, the height of the cell contact portion 121 at an end may be shorter or taller than the height of cell contact portion 121 in the middle. In one example, the contact angle θ at an end of the cell contact portion 121 may be greater or less than the contact angle θ in the middle of the cell contact portion 121.

If the cell contact portion 121 is configured as above, a sufficient contact area between the cell contact portion 121 and the side portion of the battery cell 110 may be secured, so that the heat transfer effect between the battery cell 110 and the cell contact portion 121 may be improved. Moreover, since the cell contact portion 121 may uniformly and closely support the plurality of battery cells 110, the rigidity and structural stability of the cell array structure 100 may be further improved.

In some examples, the total battery cell contact surface area SAₜₒₜₐₗ of the cell array structure 100 is a sum of all the battery cell contact surface areas SA of the side structure 120, 120′ included in the cell array structure 100. In some examples, the total contact area SBₜₒₜₐₗ for cell array structure 100 is the sum of the contact areas SB of the side structure 120, 120′ included in the cell array structure 100.

The relationship between the battery cell contact surface area SA and the contact area SB may be selected. For instance the SAₜₒₜₐₗ:SBₜₒₜₐₗ ratio may be selected to be in ranges of about 1:1≤SAₜₒₜₐₗ:SBₜₒₜₐₗ≤1:0.05; 1:0.9≤SAₜₒₜₐₗ:SBₜₒₜₐₗ≤1:0.1; 1:0.8≤SAₜₒₜₐₗ:SBₜₒₜₐₗ≤1:0.2; 1:0.75≤SAₜₒₜₐₗ:SBₜₒₜₐₗ≤1:0.25; or 1:0.6≤SAₜₒₜₐₗ:SBₜₒₜₐₗ≤1:0.4 or the ratio of SAₜₒₜₐₗ:SBₜₒₜₐₗ may be about 1:0.5.

TABLE 1
comparing the properties of materials used in conventional side structures against
those in the side structure 120, 120′ according to the present disclosure.

| | | Conventional Side Structure | Side Structure |
|---|---|---|---|
| | | (Material: MPPO) | (Material: Al) |
| Density(kg/m3) | | MPPO: 1170 | Aluminum: 2700 |
| | | Foaming Rate 15%: 994.5 | Epoxy: 1300 |
| Specific Heat(J/(kg · ° C.)) | | MPPO: 1340 | Al: 900 |
| Heat Capacity(J/° C.) | | 462.3 | 165.6 |
| Thermal Conductivity | | 0.23 | 206 |
| (W/(K · m)) | | | |
| (W/(K · m)) | Weight (g) | 345 | 220 |
| | Weight | — | 37% ↓ |
| | Comparison | | |

| | | |
|---|---|---|
| Thickness | T1.4~12.2 mm | Total Thickness 1.8T |
| | | (Al 1.2T~1.4T, Epoxy 0.3T~0.2T) |

Referring to FIGS. 5, 6, and Table 1, the side structure 120, 120′ may contain a metal material. That is, the side structure 120, 120′ may be made of a metal material. The side structure 120, 120′ may contain a metal material with high thermal conductivity. For example, a metal material having a thermal conductivity, at ambient temperature, in a range greater than 75 W/(K·m), greater than 100 W/(K·m), greater than 150 W/(K·m), greater than 200 W/(K·m), or greater than 225 W/(K·m) may be preferable. The thermal conductivity of a composite side structure 120, 120′ may have an overall thermal conductivity affected by the thermal conductivities of the materials of the composite side structure. For example, a composite side structure having a thermal conductivity, at ambient temperature, of greater than 60 W/(K·m), greater than 75 W/(K·m), greater than 125 W/(K·m), greater than 190 W/(K·m), or greater than 200 W/(K·m) may be preferable.

If the side structure 120, 120′ contains a metal material as above, the cooling performance and rigidity of the cell array structure 100 may be improved. Also, even if the side structure 120, 120′ is provided in a relatively thin or small size, the cell array structure 100 may be configured to be compact, and the energy density of the cell array structure 100 may be improved.

The metal material may include aluminum (Al) or an alloy thereof. Aluminum may be a material with excellent thermal conductivity, high heat capacity, and light weight due to low density. The side structure 120, 120′ may include, for example, an aluminum material such as AL3003. The thermal conductivity of AL3003 may be about 150 to 190 W/(K·m). The selection of the material may be made in consideration of not only thermal conductivity but also workability. Other metals having high thermal conductivity, such as magnesium (Mg), or copper (Cu), or silver (Ag), or alloys thereof, may be included in the metal material.

If the side structure 120, 120′ contains aluminum material, the cooling performance and rigidity of the cell array structure 100 may be improved, the compactness may secured, and weight may be reduced, so that the energy density may be further improved.

Additionally, referring to Table 1, the conventional side structure may have very low thermal conductivity and heavy weight since it contains a plastic material (e.g., modified polyphenylene oxide (MPPO)). However, the side structure 120, 120′ according to the present disclosure may contain a metal material such as aluminum, and may be formed to have very high thermal conductivity, thereby providing even better cooling performance for the battery cell 110. Moreover, it may be found that the side structure 120, 120 according to the present disclosure may be significantly reduced in volume compared to the conventional side structure, and thus its weight may be significantly reduced (approximately 37% reduction compared to the conventional side structure).

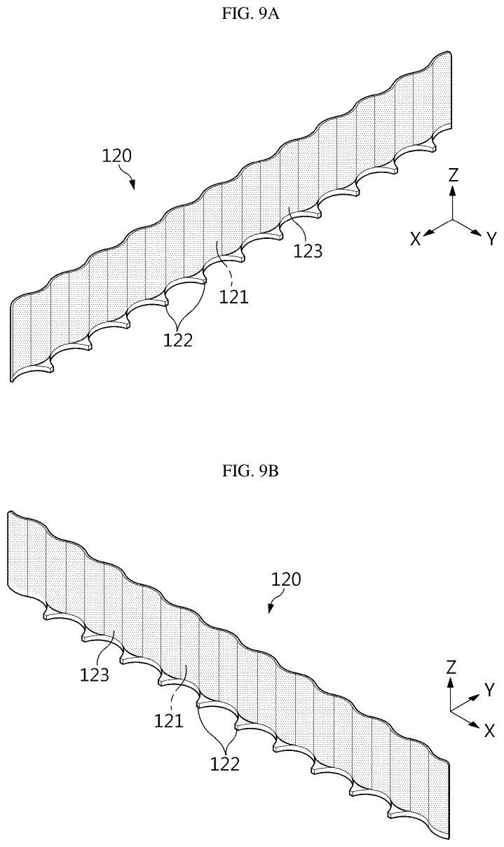

FIGS. 9A and 9B are perspective views showing a side structure according to another aspect of the present disclosure.

Referring to Table 1, FIG. 9A, and FIG. 9B, a cell array structure 100 according to another aspect of the present disclosure will be described in detail. A side structure 120, 120′ of the cell array structure 100 according to another aspect of the present disclosure may include an insulating coating layer 123 formed thereon.

Specifically, the side structure 120, 120′ may be a composite side structure. In one example, the composite side structure 120, 120′ may include an insulating coating layer 123 formed on at least a partial surface thereof. The insulating coating layer 123 may be formed on the cell contact portion 121, for example, as shown in FIG. 9A and FIG. 9B. Although not illustrated in the drawing, the insulating coating layer 123 may also be formed on the cooling member contact portion 122.

The insulating coating layer 123 may be formed at both sides in the Y-axis direction of the side structure 120, as shown in FIG. 9A and FIG. 9B.

The insulating coating layer 123 may contain an insulating material. The insulating coating layer 123 may be understood as a layer in which an insulating material is coated on the outer surface of the side structure 120, 120.

The insulating material may contain an epoxy material. The epoxy material may have excellent electrical insulating properties. However other insulating materials may be used either alone or in combination. For instance, silicone, urethane, or acrylic may be used as the insulating material. The insulating material may be an electrical insulator, which may, for example, have an electrical resistivity of about 10⁸ to about 10¹⁸ Ω·cm or more. The insulating material may be any material with a high resistance to the flow of electrons therethrough.

TABLE 2
Aluminum to epoxy thickness ratios and corresponding
aluminum and epoxy volumes

| Thickness Ratio (Al:Epoxy) | Al Volume (%) | Epoxy Volume (%) |
|---|---|---|
| 1.2T:0.3T | 68% | 32% |
| 1.3T:0.25T | 74% | 36% |
| 1.4T:0.2T | 80% | 20% |

Varying with the aluminum and epoxy thickness ratios (Al 1.2 T˜1.4 T, Epoxy 0.3 T˜0.2 T), assuming a volume ratio of 1 part to 100%, the aluminum volume ratio can be selected to be about 65-80%.

If an insulating coating layer 123 is formed on the side structure 120, 120′ as above, electrical insulation between the side structure 120, 120′ and the battery cell 110 may be secured.

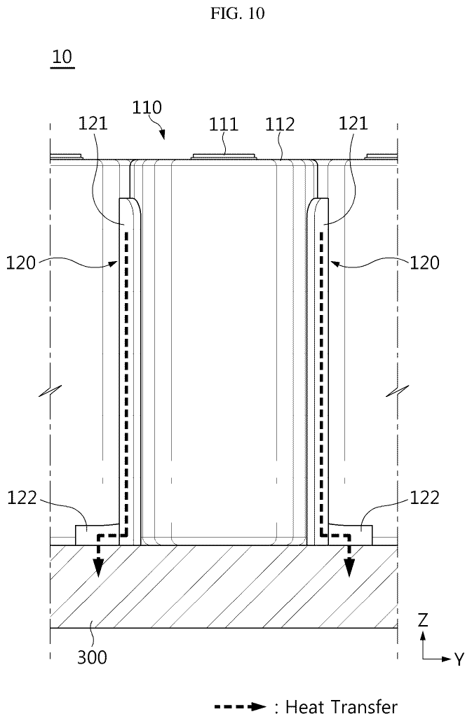

FIG. 10 is an enlarged front view showing a portion of a battery pack according to an aspect of the present disclosure.

Referring to FIGS. 1, 2, and 10, the battery pack 10 according to an aspect of the present disclosure may further include a cooling member 300 as described above. The cooling member 300 may be arranged in contact with the cooling member contact portion 122 of the side structure 120, 120′ at the bottom portion of the cell array structure 100, and thus, the cell array structure 100 may be provided in a bottom cooling structure. Heat generated in the battery cell 110 may sequentially pass through the cell contact portion 121 and the cooling member contact portion 122, and be finally transferred to the cooling member 300.

Meanwhile, referring to FIGS. 1 and 2 again, the battery pack 10 according to the present disclosure may further include a pack case 200. An accommodation space for accommodating at least one cell array structure 100 may be formed inside the pack case 200. The pack case 200 may further include a bottom plate 210, a side wall portion 220, and a pack lid 230. The bottom plate 210 may form a bottom of the pack case 200. The side wall portion 220 may surround the bottom plate 210 and, together with the bottom plate 210, form an accommodation space for accommodating at least one cell array structure 100. The cooling member 300 may be disposed in a state of being accommodated in the accommodation space on the bottom plate 210. The pack lid 230 may be configured to cover the accommodation space. The pack case 200 may further include a cross beam configured to partition the accommodation space.

Meanwhile, referring to FIGS. 3 and 4 again, the cell array structure 100 may further include a side wall 130. The side wall 130 may be arranged at the outermost side of the cell array structure 100. For example, the side wall 130 may be arranged at both outermost sides in the Y-axis direction of the cell array structure 100. The side wall 130 may accommodate and support a row of battery cells 110 at one side (the +Y-direction side or the −Y-direction side). The side wall 130 may be configured to be elongated along the longitudinal direction of the cell array structure 100. For example, the side wall 130 may be elongated along the X-axis direction like the side structure 120.

Meanwhile, the battery pack 10 according to the present disclosure may further include various components in addition to the components described above, for example components of the battery pack known at the time of filing of this application, such as a BMS (Battery Management System), a relay, a current sensor, etc.

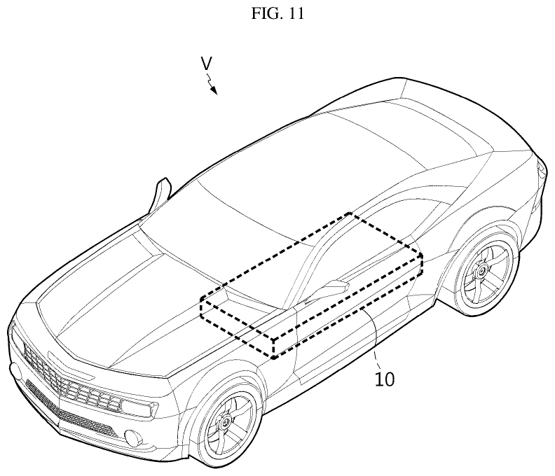

FIG. 11 is a drawing showing a vehicle according to an aspect of the present disclosure.

Hereinafter, referring to FIG. 11, the battery pack 10 according to an aspect of the present disclosure may be applied to a vehicle V such as an electric vehicle or a hybrid electric vehicle. That is, a vehicle V according to the present disclosure may include the battery pack 10 according to the present disclosure. The battery pack 10 may be installed in a body frame under a vehicle seat or in a trunk space. In addition to the battery pack 10, the vehicle V according to an aspect of the present disclosure may further include various other components provided in the vehicle. For example, the vehicle V according to an aspect of the present disclosure may further include a car body, a motor, a control device such as an ECU (electronic control unit), or the like, in addition to the battery pack 10 according to an aspect of the present disclosure.

In addition, the battery pack 10 according to an aspect of the present disclosure may also be installed in other devices, apparatuses, and facilities such as an energy storage system using secondary batteries, in addition to the vehicle V.

Meanwhile, although terms indicating directions such as upper, lower, left, right, front and rear directions are used in this specification, it is obvious to those skilled in the art to which the present disclosure pertains that these terms are only for convenience of explanation with reference the relevant drawings and may vary depending on the position of the target object or the position of the observer.

The present disclosure has been described in detail. However, it should be understood that the detailed description and specific examples, while indicating preferred aspects of the disclosure, are given by way of illustration only, since various changes and modifications within the scope of the disclosure will become apparent to those skilled in the art from this detailed description.

### REFERENCE CHARACTERS USED IN THE PRESENT DISCLOSURE ARE AS FOLLOWS

10: battery pack
100: cell array structure
110: battery cell
111: first electrode terminal
112: second electrode terminal
120, 120′: side structure
121: cell contact portion
122: cooling member contact portion
123: insulating coating layer
130: side wall
200: pack case
210: bottom plate
220: side wall portion
230: pack lid
300: cooling member
A: contact angle
V: vehicle

What is claimed is:

1. A cell array structure comprising:
a plurality of battery cells; and
at least one side structure configured to accommodate and support battery cells of the plurality of battery cells,
wherein the at least one side structure includes:
a cell contact portion configured such that at least a portion thereof is in contact with battery cells of the plurality of battery cells; and
a cooling member contact portion having a bottom surface formed to be in contact with a predetermined area of a cooling member,
wherein the at least one side structure is configured to transfer heat between battery cells of the plurality of battery cells and the cooling member via the cell contact portion and the cooling member contact portion.

2. The cell array structure according to claim 1,
wherein battery cells of the plurality of battery cells have a first electrode terminal and a second electrode terminal at a top portion.

3. The cell array structure according to claim 1,
wherein the cooling member contact portion includes a portion extending from a bottom portion of the cell contact portion toward a space between adjacent battery cells of the plurality of battery cells.

4. The cell array structure according to claim 1,
wherein the bottom surface of the cooling member contact portion is flat.

5. The cell array structure according to claim 1,
wherein the bottom surface of the cooling member contact portion has the same vertical position relative to the cooling member as a bottom surface of battery cells of the plurality of battery cells.

6. The cell array structure according to claim 1,
wherein battery cells of the plurality of battery cells are arranged in rows, and at least one side structure is arranged along each row of battery cells.

7. The cell array structure according to claim 1,
wherein the cell contact portion is in surface contact with side portions of battery cells of the plurality of battery cells.

8. The cell array structure according to claim 7,
wherein a contact angle between the cell contact portion and the battery cells is from 50 to 70 degrees.

9. The cell array structure according to claim 1,
wherein the side structure includes a metal.

10. The cell array structure according to claim 9,
wherein the metal includes aluminum.

11. The cell array structure according to claim 1,
wherein the side structure has an electrically insulating coating layer formed on at least a partial surface thereof, and
wherein the electrically insulating coating layer contains an electrically insulating material.

12. The cell array structure according to claim 11,
wherein the electrically insulating material includes an epoxy material.

13. A battery pack comprising at least one cell array structure according to claim 1.

14. The battery pack according to claim 13, further comprising:
a cooling member arranged at a bottom portion of the cell array structure.

15. A vehicle comprising at least one battery pack according to claim 13.

16. A side structure for accommodating and supporting battery cells in a battery cell array structure, the side structure comprising:
a cell contact portion configured such that at least a portion thereof is configured to be in contact with the battery cells; and
a cooling member contact portion having a bottom surface configured to be in contact with a predetermined area of a cooling member,
wherein the side structure includes metal and is configured to transfer heat between a plurality of battery cells and the cooling member.

17. The side structure of claim 16,
wherein the side structure has an electrically insulating coating layer formed on at least a partial surface thereof, and
wherein the electrically insulating coating layer contains an electrically insulating material.

18. The side structure according to claim 17,
wherein the electrically insulating material includes an epoxy material.

19. The side structure according to claim 16,
wherein the cell contact portion has a corrugated shape.

20. The side structure according to claim 16,
wherein the cooling member contact portion is one among a plurality of cooling member contact portions extending alternately on opposing sides of the side structure.

21. The side structure according to claim 16,
wherein the cooling member contact portion is one among a plurality of cooling member contact portions extending on only one side of the side structure.
